(19) United States
(12) Patent Application Publication
(10) Pub. No.: US 2005/0063673 A1
(43) Pub. Date: Mar. 24, 2005

(54) Recording apparatus

(75) Inventor: Masamine Maeda, Chiba (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Tokyo (JP)

(21) Appl. No.: 10/939,671

(22) Filed: Sep. 13, 2004

(30) Foreign Application Priority Data
Sep. 19, 2003 (JP) 2003-328075

(51) Int. Cl. H04N 5/76; G06F 3/00; G06F 13/00

(52) U.S. Cl. 386/83; 725/58

(57) ABSTRACT

A recording apparatus includes a recording section for recording received broadcasting programs into a recording medium, a reservation setting section for setting reservation information for recording broadcasting programs, a mode selecting section for selecting a reservation mode for setting priority levels for the set reservation information for recording broadcasting programs, and a controlling section for controlling recording operations of the broadcasting programs by the recording section based on the set priority levels.

### CROSS REFERENCE TO RELATED APPLICATIONS

This application claims priority from Japanese Patent Application No. 2003-328075 filed Sep. 19, 2003, which is hereby incorporated by reference herein.

### BACKGROUND OF THE INVENTION

1. Field of the Invention

The present invention relates to a recording apparatus and more particularly to a video recording reservation setting process.

2. Description of the Related Art

In the past, when sharing one video deck by a plurality of users, such as family, each user managed a respective video tape as a recording medium.

Recently, use of video decks of a type in which a large capacity hard disk drive (HDD) is built in a body for recording many programs has rapidly spread.

When sharing such a video deck by a plurality of users, one HDD is also shared. In such a case, since the HDD is a large capacity medium, it permits a variety of uses, such as recording tens of hours of broadcasting programs, freely reading/writing and deleting, quickly deleting just after watching recorded programs, copying for other media, etc., and causes little inconvenience even though the medium cannot be exchanged.

However, a video deck using such an HDD might have the problem of a lack of remaining capacity of the HDD if the recorded programs are kept therein without deletion.

As described in Japanese Unexamined Patent Application Publication No. 2003-009048, it is known to compare the broadcasting time length of a program with the remaining capacity for recording of the HDD and to inform the user of the lack of remaining capacity for recording in the case of the lack of remaining capacity for recording.

However, though the remaining capacity of a medium is enough for reservation setting by, for example, one person, a reserved program might not be recorded if the remaining capacity of the medium is lacking because of another person's recording.

### SUMMARY OF THE INVENTION

The present invention provides an optimal recording reservation mechanism even when one recording apparatus is shared by many users.

According to an aspect of the present invention, a recording apparatus comprises: receiving means for receiving broadcasting programs; recording means for recording the broadcasting programs received by the receiving means onto a recording medium; reservation setting means for setting reservation information for recording of specified broadcasting programs; reservation mode selecting means for selecting a reservation mode for setting priority levels among the reservation information for the specified broadcasting programs having reservation information set by the reservation setting means; and controlling means for controlling recording operations of the broadcasting programs by the recording means according to the reservation information set by the reservation setting means and the reservation mode selected by the reservation mode setting means.

Further features and advantages of the present invention will become apparent from the following description of the preferred embodiments with reference to the attached drawings.

### BRIEF DESCRIPTION OF THE DRAWINGS

FIG. 1 shows a structure of a disk recorder according to the present invention.

FIGS. 2A and 2B show a flowchart illustrating a reservation setting process.

FIG. 3 shows a table illustrating an example of reservation setting information.

FIG. 4 shows an example of a warning display.

FIG. 5 shows a table illustrating another example of reservation setting information.

FIG. 6 shows another example of a warning display.

### DESCRIPTION OF THE EMBODIMENTS

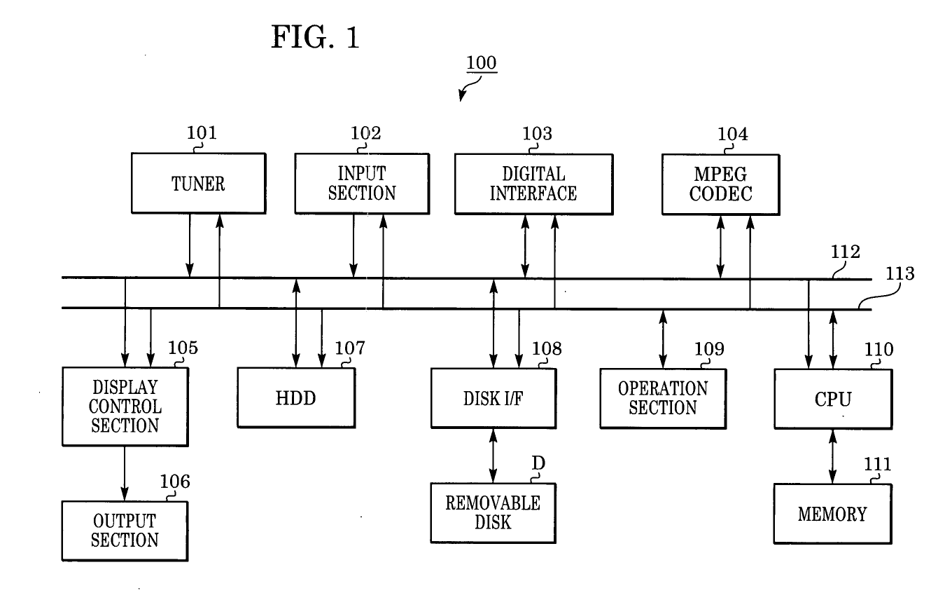

FIG. 1 shows a structure of a disk recorder 100 according to the present invention. The exemplary disk recorder 100 includes a tuner 101, an input section 102, a digital interface 103, a Moving Picture Experts Group (MPEG) coder-decoder (CODEC) 104, a display control section 105, a built-in hard disk drive (HDD) 107 having a large capacity, a disk interface (I/F) 108, an operation section 109 and a central processing unit (CPU) 110. These various components are connected to and communicate with each other via a data bus 112 and a control bus 113. The data bus 112 transfers data among respective components/blocks, and the control bus 113 is used for transmitting/receiving of control signals to/from the respective components/blocks by the CPU 110.

The tuner 101 tunes/detects a radio frequency (RF) input such as base station (BS), ground wave, cable television (CATV), etc. received by an antenna (not shown in the drawings) and takes out/digitizes/outputs image and voice signals. The input section 102 inputs the image and voice signals from outside equipment and converts the input signals and outputs digital signals. The digital interface 103 transmits/receives the image and voice signals in a digital data style to/from the outside equipment. The MPEG CODEC 104 encodes/decodes the image and voice signals according to the MPEG standard. The display control section 105 generates display pictures for displaying the decoded image signals and various types of menu pictures on an outside monitor connected to an output section 106. The output section 106 converts/outputs the image signals from the display control section 105 into a format appropriate for the outside monitor. The disk I/F 108 writes/reads data into/from a removable disk D. The operation section 109 inputs various types of instructions/directions for the recorder 100. The CPU 110 controls processing of each component/part/module of the recorder 100. A memory 111 stores data required for processing by the CPU 110. In exemplary embodiments, an optical disk such as a Digital Versatile Disc (DVD) is used as the disk D.

At the time of recording, image and voice signals obtained from the tuner 101 are encoded by the CODEC 104. MPEG stream data obtained by the CODEC 104 is transmitted to the HDD 107 or the disk I/F 108 and recorded in the HDD or the disk D.

By operation of the operation section 109, a user can select the HDD 107 or the disk D and record the image and voice signals thereinto.

At the time of reproducing, when the user selects the HDD 107 or the disk D and indicates reproduction by the operation section 109, the CPU 110 controls the HDD 107 and the I/F 108 so as to reproduce specified data from the HDD 107 or the disk D. The reproduced MPEG stream data is decoded by the CODEC 104 and transmitted to the output section 106 via the display control section 105. The output section 106 outputs the reproduced image signals to an outside monitor.

Reservation video recording operations are described next.

The recorder 100 of the exemplary embodiment described herein includes reservation video recording functions, and the user switches the recorder 100 into a reservation video recording mode by operation of the operation section 109. When configured to the reservation video recording mode, the CPU 110 controls the display control section 105, generates a picture for reservation video recording and displays the picture on the outside monitor via the output section 106. In conjunction with viewing the display picture, the user reserves video recording by operation of the operation section 109.

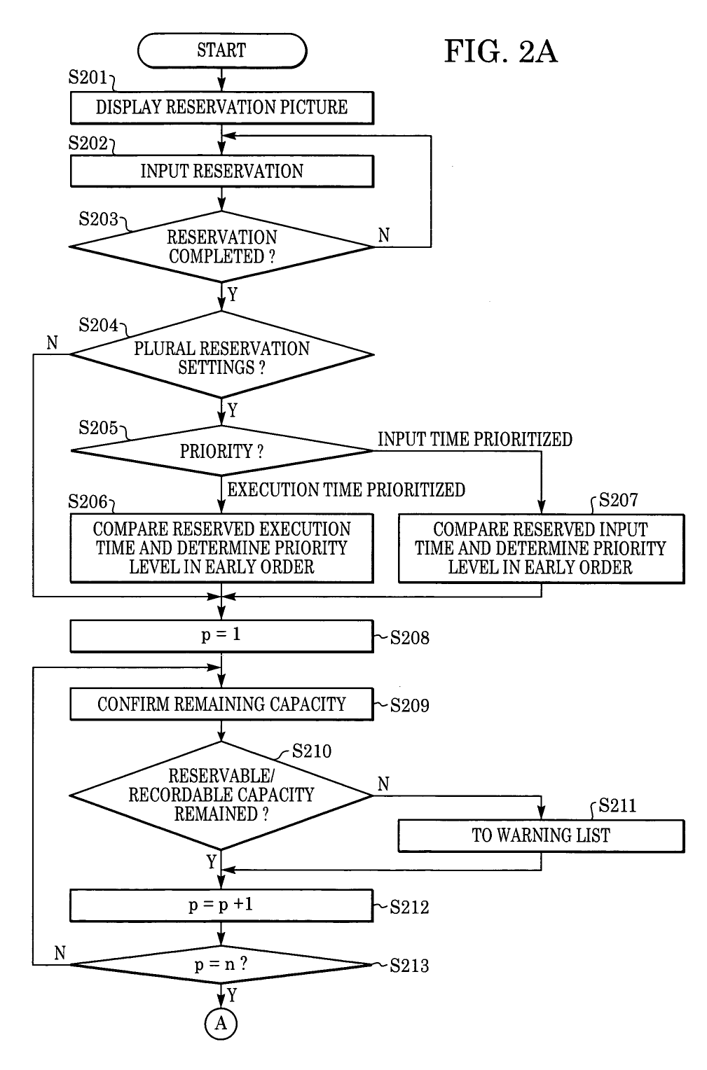

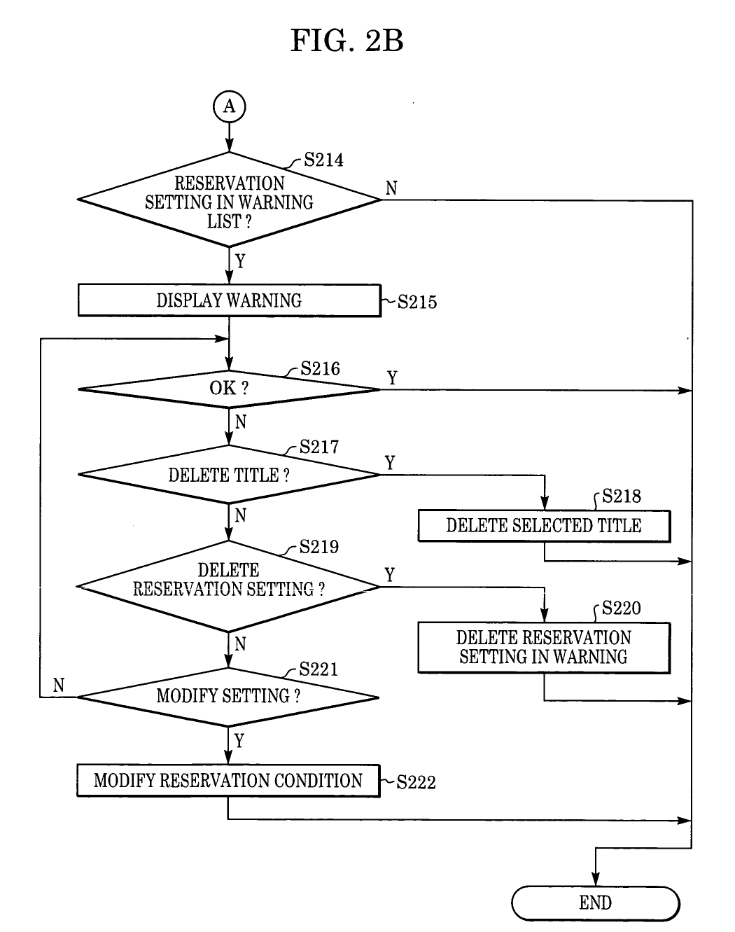

FIG. 2 shows a flowchart illustrating a process of the CPU 110 at the time of video recording. Referring to FIG. 2, as below described is a process at the time of video recording reservation processing.

When a reservation video recording reservation process is indicated, a reservation picture is displayed as described above (S201) and a reservation condition is input by a user (S202) until the reservation input is completed. At the time of completion of the reservation input (yes in S203), it is determined whether reservation information is currently set for more than one item (S204). If there are more than one currently set reservation information items (yes in S204), a priority mode is determined (S205). In the exemplary embodiment, the priority mode is either a reservation execution time prioritized mode or a reservation input time prioritized mode. By operation of the operation section 109, the user can select either one of the reservation execution time prioritized mode or the reservation input time prioritized mode from a menu picture.

The reservation execution time prioritized mode is a mode for determining priority in condition of recording start time by corresponding reservation information. In this case, recording start time by the corresponding reservation information is compared and priority levels are determined such that the higher priority of the reservation information is set to the reservation information item having the earlier recording start date/time of the set programs (S206).

The reservation input time prioritized mode is a mode for determining priority in condition of time of completion of reservation setting. In this case, the time of completion of reservation input and priority levels are determined such that the higher priority of the reservation information is set to the earlier date/time of completion of reservation input of the set programs (S207).

Next, among n number of reservation information items, one is configured (set) to a variable p indicating priority, and the reservation information item having the highest priority is selected (S208). If there are more than one reservation items, the reservation information item having the highest priority is set based on execution time (S206) or input time (S207). The remaining capacity of a designated recording medium of either of the HDD 107 or the disk D is checked (S209), and it is determined whether the remaining capacity is large enough for recording the designated programs (S210). When the remaining capacity is not enough (no in S210), the corresponding reservation information is stored for a warning list in a memory 111 (S211).

When the remaining capacity is determined to be enough (yes in S210), reservation information of the next priority level is selected (S212), and it is determined whether all of n of reservation information are checked (S213). When reservation items to be checked remain (no in S213), processing returns to step S209, and similar processes as described above is repeated. When checking reservation items of second or lower priority levels, in step S209, in addition to the current remaining capacity, the data quantity of the programs already checked to be recorded by the reservation information with higher priority is taken into consideration and the remaining capacity is checked.

At the time of completion of checking of the remaining capacity for all the reservation items (yes in S213), it is determined whether there are reservation items in the “to warn” list (S214). If there are no reservation items in the “to warn” list (no in S214), processing ends. However, if there are item(s) in the “to warn” list (yes in S214), the reservation item(s) and warning contents recorded in the warning list are displayed (S215).

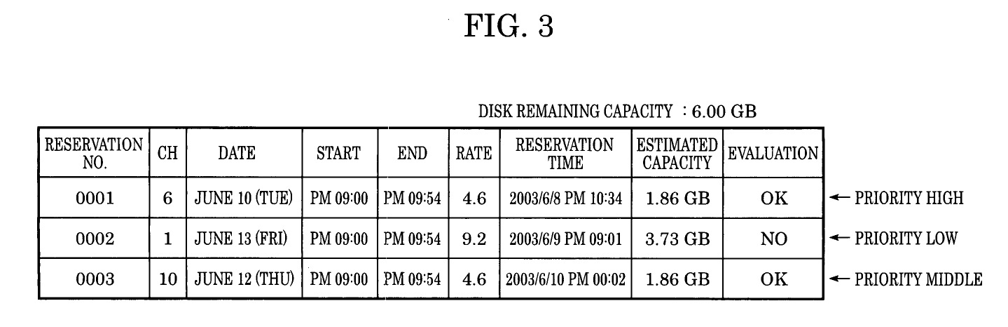

FIG. 3 shows a table for illustrating a manner for checking the remaining capacity in the reservation execution time prioritized mode. In FIG. 3, three video recording reservations of reservation numbers 0001 to 0003 are set.

In comparison of start dates/times of video recording of these three reservations, since the reservation number 0001 is for 9:00 P.M. on June 10 (Tue), the reservation number 0002 for 9:00 P.M. on June 13 (Fri), and the reservation number 0003 for 9:00 P.M. on June 12 (Thu), the priority levels are from highest to lowest: reservation number 0001 (June 10), reservation number 0003 (June 12), and reservation number 0002 (June 13). In FIG. 3, since the remaining capacity is 6 GB, in this condition, the remaining capacity for executing reservation video recording for the reservation number 0002 of the lowest priority level is lacking and the whole program set by the reservation number 0002 cannot be fully recorded, and accordingly, a warning should be displayed.

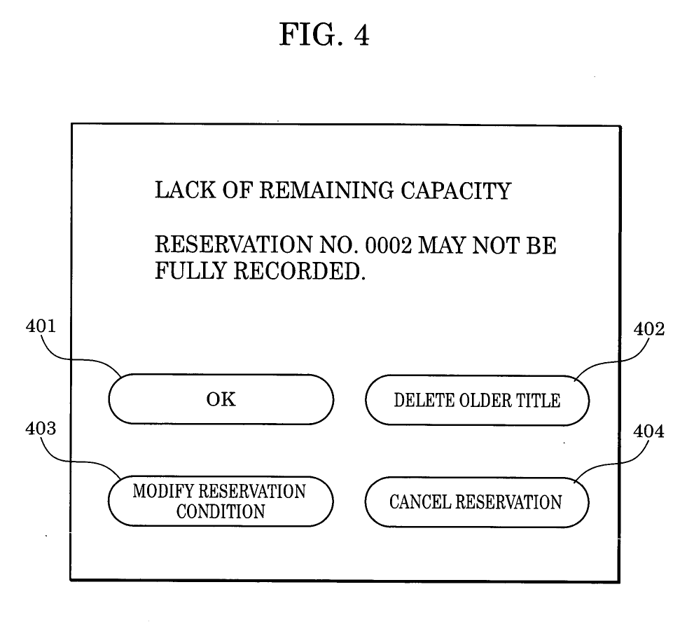

FIG. 4 shows an exemplary warning display.

In FIG. 4, the exemplary warning display provides three options/user selections in response to the warning. The user indicates his/her response/selection by selecting one of the selection buttons 401-404. One of the selection buttons is an OK button 401. When the OK button 401 is selected (S214 in FIG. 2), the reservation is kept set in the original condition, and recording of the program designated by the reservation item of lower priority, in this case, the reservation number 0002 is stopped in the middle unless reservation conditions of higher priority are modified. Processing of FIG. 2 then ends.

Another selection button (in FIG. 4) is a Delete Older Title selection button 402. When the Delete Older Title selection button 402 is selected (S217 of FIG. 2), specific data of the data recorded in the HDD 107 or the disk D is deleted. For example, deletion may occur based on the order of older recordings, and a region for the reservation video recording is secured (S218). Another method of deletion is based on user selection, wherein a display showing older recordings is displayed (not shown) and the user selects one or more recordings to be deleted. After the selected title(s) is deleted (S218), processing of FIG. 2 ends.

Another selection button is a Cancel Reservation button 404. When the Cancel Reservation button 404 is selected (S219 of FIG. 2), reservation of the reservation item in the warning display, in this case, the reservation number 0002 is canceled (S220) and processing of FIG. 2 ends.

Another selection button is a Modify Reservation Condition button 403. When the Modify Reservation Condition button 403 is selected (S221 in FIG. 2), the reservation condition can be modified (S222). For example, the video recording time may be shortened or the recording bit rate may be lowered, so that the reservation can be completed. For example, in FIG. 4, if the bit rate setting of 9.2 Mbps is modified to 5.8 Mbps or less, all of the reserved programs can be recorded. After the reservation condition has been modified to allow for the reservation having the warning to have sufficient space for recording (S222), processing of FIG. 2 ends.

In the reservation execution time prioritized mode, regardless of the user, anyone can modify the reservation. Therefore, when there is only one user, the reservation execution time prioritized mode may be the optimal mode.

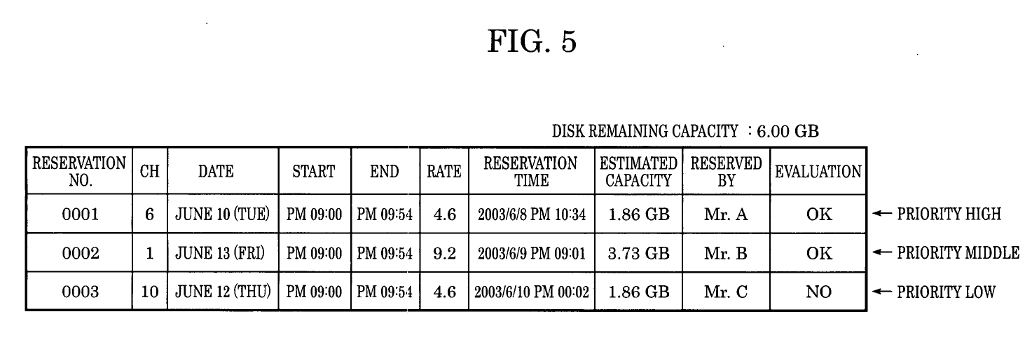

FIG. 5 shows a table for illustrating a manner for checking the remaining capacity in the reservation input time prioritized mode. In FIG. 5, three video recording reservations of reservation numbers 0001 to 0003 are set.

In comparison of time of reservation setting completion of these three reservations, since the input time of reservation number 0001 is 10:34 P.M. on June 8, the input time of reservation number 0002 is 9:01 P.M. on June 9, and the input time of reservation number 0003 is 0:02 P.M. on June 10, the priority levels are from highest priority to lowest priority: reservation number 0001 (June 8), reservation number 0002 (June 9), and reservation number 0003 (June 10).

Based on the priorities for the reservations shown in FIG. 5, there is not sufficient remaining capacity for executing the entire recording for reservation number 0003 (the lowest priority level reservation). Accordingly, a warning regarding the lack of remaining recording capacity for reservation number 0003 should be displayed.

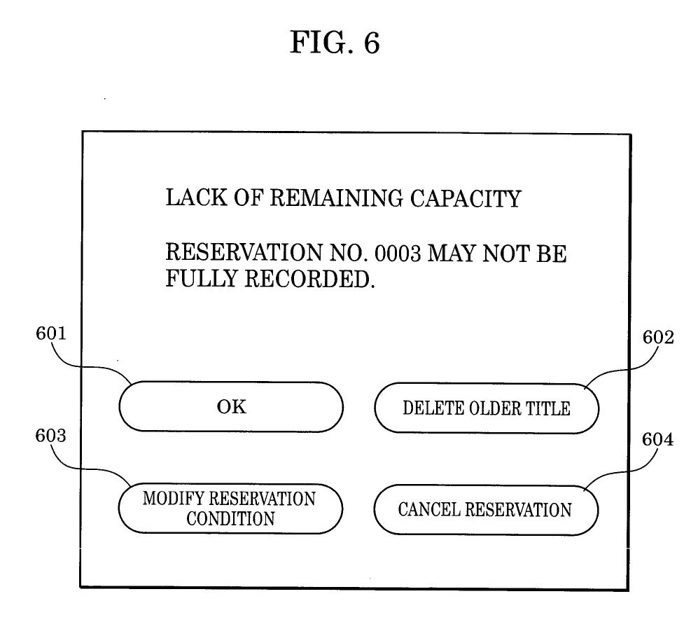

FIG. 6 shows an exemplary warning display based on the example reservations of FIG. 5.

In FIG. 6, similarly to FIG. 4, by corresponding operation of an OK button 601, a Delete Older Title button 602, a Cancel Reservation button 603 and a Modify Reservation Condition button 604, the reservation can be completed or modified as described above with reference to FIGS. 2 and 4.

By registering a user name at the time of reservation, the user name can be displayed in a column for reserving person as shown in FIG. 5. Furthermore when modifying or deleting the reservation contents, the apparatus can be a configured to require inputting of a user password, and this may be the optimal reservation prioritized mode when one recorder is shared by multiple users.

As described above, in this embodiment, the two priority modes of the reservation execution time prioritized mode and the reservation input time prioritized mode allow flexibility so that an optimal mode can be used, for example, based on the number of users.

Although the embodiment described herein is an apparatus for recording the broadcasting programs received by the HDD, the present invention can be similarly applied to an apparatus for recording the programs into other recording medium(s), such as a magnetic tape or an optical disc.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A recording apparatus comprising:
receiving means for receiving broadcasting programs;
recording means for recording the broadcasting programs received by the receiving means onto a recording medium;
reservation setting means for setting reservation information for recording of specified broadcasting programs;
reservation mode selecting means for selecting a reservation mode between plural reservation modes for setting priority levels among the reservation information for the broadcast programs set by the reservation setting means; and
controlling means for controlling recording operations of the broadcasting programs by the recording means according to the reservation information set by the reservation setting means and the reservation mode selected by the reservation mode setting means.

2. The recording apparatus according to claim 1, wherein
the controlling means comprises remaining capacity detecting means for detecting remaining recordable capacity of the recording medium and the controlling means determines whether the recording medium has remaining recordable capacity for recording all of the broadcasting programs having reservation information set by the reservation setting means according to a detection result of said remaining capacity detecting means, the controlling means further determines which of the broadcasting programs having reservation information are to be recorded and which of the broadcasting programs having reservation information are not to be recorded based on the priority levels of the broadcasting programs having reservation information, if the recording medium does not have remaining recordable capacity for recording all of the broadcasting programs having reservation information.

3. The recording apparatus according to claim 2, further comprising
display controlling means for outputting warning information about the broadcasting programs determined by the controlling means not to be recorded when the recording medium does not have remaining recordable capacity for recording all of the broadcasting programs having reservation information.

4. The recording apparatus according to claim 3, wherein
the reservation setting means receives user input specifying modification information for one or more of the broadcasting programs determined by the controlling means not to be recorded and the reservation setting means modifies the reservation information for respective broadcasting programs based on the user input received.

5. The recording apparatus according to claim 4, wherein
authentication of a person providing the user input specifying the modification information is required if the priority selected by the reservation mode selecting means is based on a recording date and a recording time for the broadcasting programs.

6. The recording apparatus according to claim 2, wherein
the controlling means determines if the recording medium has remaining recordable capacity for recording all of the broadcasting programs having reservation information each time the reservation setting means sets reservation information for recording of a respective broadcasting program, and if the recording medium does not have remaining recordable capacity for recording all of the broadcasting programs having reservation information, the controlling means determines which of the broadcasting programs having reservation information are to be recorded and which of the broadcasting programs having reservation information are not to be recorded based on the priority levels of the broadcasting programs having reservation information.

7. The recording apparatus according to claim 2, wherein
the controlling means deletes specified data of the broadcasting programs recorded in the recording medium according to a deletion indication when the recording medium does not have remaining recordable capacity for recording all of the broadcasting programs having reservation information.

8. The recording apparatus according to claim 1, wherein,
in one of the plural reservation modes, the priority levels of the reservation information for the broadcasting programs is set based on a recording date and a recording time for the broadcasting programs.

9. The recording apparatus according to claim 1, wherein,
in one of the plural reservation modes, the priority levels of the reservation information for the broadcasting programs is set based on an entry input date and an entry input time of the reservation information.

10. A recording apparatus comprising:
receiving means for receiving broadcasting programs;
reservation setting means for setting reservation information for recording specified broadcasting programs to be received by the receiving means;
recording means for recording broadcasting programs received by the receiving means into a recording medium as specified in the reservation information set by the reservation setting means;
condition selecting means for selecting a specific condition between plural conditions for setting priority levels on the reservation information set by the reservation setting means; and
controlling means for setting priority levels for the reservation information according to the specific condition selected by the condition selecting means, and for controlling recording operations of the broadcasting programs by the recording means according to the set priority levels of the reservation information.

11. The recording apparatus according to claim 10, wherein
the controlling means comprises remaining capacity detecting means for detecting remaining recordable capacity of the recording medium and the controlling means determines which of the broadcasting programs having reservation information are to be recorded and which of the broadcasting programs having reservation information are not to be recorded based on the priority levels set by the controlling means when the remaining recordable capacity of the recording medium is not sufficient for recording all of the broadcasting programs to be recorded in the recording medium as specified by the reservation information for the broadcasting programs.

12. The recording apparatus according to claim 11, further comprising
display controlling means for outputting warning information from the reservation information for the broadcasting programs having reservation information but determined by the controlling means not to be recorded.

13. The recording apparatus according to claim 12, wherein
the reservation setting means modifies contents of reservation information for the broadcasting program specified in the warning information.

14. The recording apparatus according to claim 11, wherein
the controlling means determines if the recording medium has remaining recordable capacity for recording all of the broadcasting programs having reservation information each time the reservation setting means sets reservation information for recording of a respective broadcasting program, and if the recording medium does not have remaining recordable capacity for recording all of the broadcasting programs having reservation information, the controlling means determines which of the broadcasting programs having reservation information are to be recorded and which of the broadcasting programs having reservation information are not to be recorded based on the priority levels of the broadcasting programs having reservation information.

15. The recording apparatus according to claim 11, wherein
the controlling means deletes predetermined data of the broadcasting programs recorded in the recording medium according to a deletion indication when the recording medium does not have remaining recordable capacity for recording all of the broadcasting programs having reservation information.

16. The recording apparatus according to claim 10, wherein
one of the plural conditions to be selected by the condition selecting means for setting priority levels is a recording date and a recording time for the broadcasting programs.

17. The recording apparatus according to claim 10, wherein
one of the plural conditions to be selected by the condition selecting means for setting priority levels is an entry input date and an entry input time of the reservation information.

18. A recording apparatus comprising:
receiving means for receiving broadcasting programs;
reservation setting means for setting reservation information for recording of specified broadcasting programs;
recording means for recording the specified broadcasting programs received by the receiving means into a recording medium;
remaining capacity detecting means for detecting remaining recordable capacity of the recording medium; and
controlling means for controlling recording operations of the broadcasting programs by the recording means according to the reservation information; and wherein
the controlling means determines the broadcasting programs to be recorded based on an order of the reservation settings when the remaining capacity detecting means determines that there is not sufficient remaining recordable capacity of the recording medium to record all of the specified broadcasting programs having reservation information set by the reservation setting means.

19. A method for receiving broadcasting programs and recording data of the received broadcasting programs into a recording medium, the method comprising:
setting reservation information for recording broadcasting programs into the recording medium;
selecting a specific condition for setting priority levels for the reservation information for recording broadcasting programs into the recording medium;
setting the priority levels for the reservation information based on the selected condition; and
controlling recording operations of the broadcasting programs based on the set priority levels and the reservation information.
